(19) United States
(12) Patent Application Publication
(10) Pub. No.: US 2026/0276144 A1
(43) Pub. Date: Sep. 17, 2026

(54) GREASE GUN INCLUDING AN AIR VENT WITH A MEMBRANE FOR PRIMING

(71) Applicant: MILWAUKEE ELECTRIC TOOL CORPORATION, Brookfield, WI (US)

(72) Inventors: Alejandro M. Damonte Vegas, Menomonee Falls, WI (US); Jean M. Uruena Montoya, Wauwatosa, WI (US); Troy C. Thorson, Cedarburg, WI (US); Colten R. Jaekel, Kenosha, WI (US)

(21) Appl. No.: 19/558,036

(22) Filed: Mar. 5, 2026

Related U.S. Application Data
(60) Provisional application No. 63/802,235, filed on May 8, 2025.
(60) Provisional application No. 63/771,791, filed on Mar. 14, 2025.

(51) Int. Cl. F16N 5/00

(52) U.S. Cl. CPC F16N 5/00

(57) ABSTRACT

A grease gun includes a housing, a motor supported in the housing, a pump assembly coupled to and driven by the motor, a pump housing supported in the housing, and at least partially supporting the pump assembly, the pump housing at least partially defining a flow path, an air vent supported in the pump housing in fluid communication with the pump assembly and the flow path, the air vent configured to allow air to pass through the air vent to an exterior of the pump housing while retaining other fluids within the pump housing.

### CROSS-REFERENCE TO RELATED APPLICATIONS

This application claims priority to U.S. Provisional Patent Application No. 63/771,791, filed on Mar. 14, 2025, and U.S. Provisional Patent Application No. 63/802,235, filed on May 8, 2025, the content of each of which is incorporated herein by reference.

### FIELD

The present disclosure relates to a grease gun, and more particularly, to an air relief valve for a grease gun.

### BACKGROUND

A grease gun may require priming when air is present in the pump assembly. A grease gun often includes a valve that allows air to be expelled from the pump assembly, however, grease is also frequently expelled along with the air. The expelled grease may accumulate on the grease gun or on work surfaces. The process of priming the grease gun and subsequent clean-up is time-consuming and impedes productivity.

### SUMMARY

The present disclosure provides, a grease gun including a housing; a motor supported in the housing; a pump assembly coupled to and driven by the motor; a pump housing supported in the housing and at least partially supporting the pump assembly, the pump housing at least partially defining a flow path; and an air vent supported in the pump housing in fluid communication with the pump assembly and the flow path, the air vent configured to allow air to pass through the air vent to an exterior of the pump housing while retaining other fluids within the pump housing.

The present disclosure provides, in another aspect, an air vent for use with a grease gun having a pump housing at least partially defining a flow path, the air vent including a plug configured to be coupled to the grease gun in communication with the flow path; and a membrane coupled to the plug, the membrane configured to allow air to pass through the plug to an exterior of the grease gun while retaining other fluids within the grease gun.

The present disclosure provides, in another aspect, a grease gun including a housing; a motor supported in the housing; a pump assembly coupled to and driven by the motor; a pump housing supported in the housing and at least partially supporting the pump assembly, the pump housing at least partially defining a flow path; an air vent supported in the pump housing in fluid communication with the pump assembly and the flow path, the air vent configured to allow air to pass through the air vent to an exterior of the pump housing while retaining other fluids within the pump housing; and a membrane at least partially supported in the air vent that permits air to pass to the exterior of the pump housing.

Other features and aspects of the subject matter will become apparent by consideration of the following detailed description and accompanying drawings.

### BRIEF DESCRIPTION OF THE DRAWINGS

FIG. 1 is a side view of a grease gun.

FIG. 2 is a perspective, section view of an embodiment of an air vent for use with the grease gun.

FIG. 3 is a section view of part of a grease gun including the air vent of FIG. 2.

FIG. 4 is a perspective, section view of another embodiment of an air vent for use with the grease gun.

FIG. 5 is a section view of part of a grease gun including the air vent of FIG. 4.

FIG. 6 is a perspective, partially transparent view of another embodiment of an air vent for use with a grease gun, illustrating components of the air vent.

FIG. 7 is another perspective view of the air vent of FIG. 6.

FIG. 8 is a perspective view of the air vent of FIG. 6, coupled to a pump housing of a grease gun.

FIG. 9 is another perspective view of the air vent of FIG. 6, coupled to the pump housing.

FIG. 10 is a perspective view of the pump housing and multiple air vents.

FIG. 11 is a section view of the pump housing and an air vent.

FIG. 12 is a side view of the air vent in FIG. 11.

FIG. 13 is a side section view of the air vent of FIG. 11.

Before any embodiments of the subject matter are explained in detail, it is to be understood that the invention is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

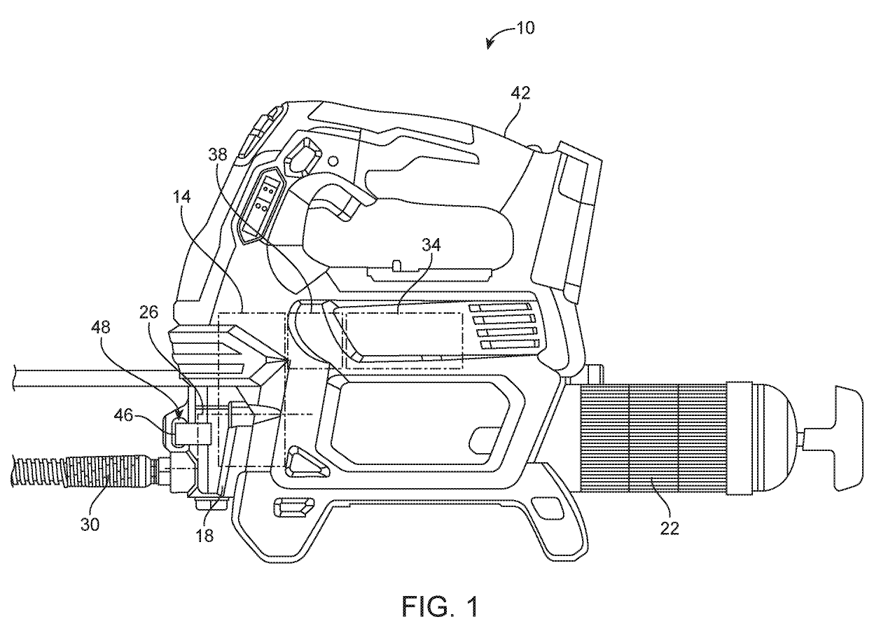

With reference to FIG. 1, a grease gun 10 includes a pump assembly 14 supported in a pump housing 18. The illustrated grease gun 10 is one example of a grease gun. In other embodiments, the grease gun 10 may have other components and/or configurations. The pump assembly 14 pumps grease from a canister 22 through a flow path 26 in the pump housing 18 and a hose 30 couplable to an external fitting. The canister 22 is coupled to the pump housing 18. The pump assembly 14 is coupled to and driven by a motor 34 coupled to a transmission 38 supported in a housing 42. The motor 34 may be a brushless DC motor, or another type of motor. In one embodiment, the transmission may be a planetary gear transmission and may include multiple stages. The transmission may be operable at different speeds to drive the pump assembly 14 at different speeds (e.g., a low speed and a high speed). The motor 34 provides a rotational output to the transmission 38, which in turn provides a rotational output to the pump assembly 14. The pump assembly 14 reciprocates in response to the rotational output from the transmission 38. Reciprocation of the pump assembly 14 dispenses grease from the canister 22 coupled to a pump housing 18. The housing 42 removably receives a battery pack (not shown), which provides a power source for the motor 34. The battery pack may be a removable and rechargeable power tool battery pack. For example, the battery pack may be an 18-volt Li-ion battery pack. In other embodiments, the grease gun 10 may be corded to receive power from an AC power source.

The canister 22 is removably couplable to the pump housing 18 (e.g., by threaded connection, a bayonet-style connection, or the like) so as to be refillable from a bulk grease supply. When refilling the canister 22 after the stored grease has been expended, air may be trapped in the pump housing 18 and/or the flow path 26. To provide a continuous supply of grease to an external fitting, the air trapped in the pump housing 18 and/or flow path 26 is relieved through an air vent 46 (or air relief valve) supported in a vent bore 48 in the pump housing 18.

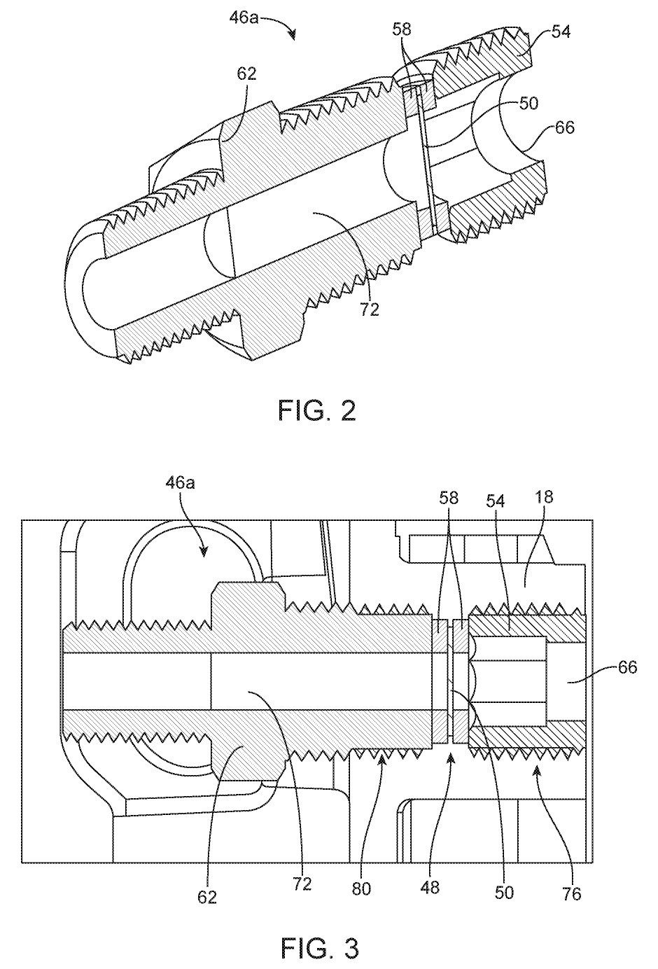

FIGS. 2-5 illustrate embodiments of air vents 46a, 46b for use with the grease gun 10. The air vents 46a, 46b include a membrane 50 configured to inhibit grease from passing through the membrane 50 while permitting air to pass through the membrane 50. The membrane 50 may also be referred to as a membrane disk. For each of the embodiments, the membrane disk 50 includes membrane materials that are oleophobic and hydrophobic, which allow air to pass through the membrane disk 50, but do not allow water, grease, or oil to pass through. In some embodiments, the membrane disk 50 may be oleophobic. In other embodiments, the membrane disk 50 may be hydrophobic. In still other embodiments, such as the illustrated embodiments, the membrane disk 50 may be both oleophobic and hydrophobic. The membrane disk 50 may be comprised of one material that is both oleophobic and hydrophobic, or may instead comprise more than one material, with one material being oleophobic and another material being hydrophobic. In some embodiments, the membrane disk 50 may be coated with an oleophobic coating and/or a hydrophobic coating, making the membrane disk oleophobic and/or hydrophobic. The membrane disk 50 therefore allows air to pass through the air vent 46a, 46b to be expelled to the exterior of the grease gun 10, while retaining the grease in the flow path 26, eliminating grease accumulation on the housing 42 of the grease gun 10 occurring during a priming operation.

With reference to FIGS. 2 and 3, a first embodiment of an air vent 46a includes a membrane disk 50 supported by a first plug 54, seals 58, and a valve 62 (e.g., a manual valve). The first plug 54 and valve 62 each have a bore 66, 72 extending through the first plug 54 and the valve 62. The first plug 54 is positioned in the vent bore 48 on an interior side 76 of the membrane disk 50, and the valve 62 is positioned in the vent bore 48 on the exterior side 80 (e.g., facing the exterior of the grease gun 10) of the membrane disk 50. In the illustrated embodiment, the first plug 54 and the valve 62 are threadably coupled to the grease gun within the vent bore 48. In other embodiments, the first plug 54 and the valve 62 may be coupled to the grease gun in other manners. The valve 62 may include a button or other actuator that is engageable to open the valve 62 and allow air to pass through the air vent 46a. The seals 58 sandwich the membrane disk 50 between the first plug 54 and the valve 62. In the illustrated embodiment, the seals 58 are O-rings. In other embodiments, the seals 58 may be other suitable seals. In the first embodiment, the grease gun 10 is configured in a clean-priming configuration, with the valve 62 requiring user input to open the valve 62 to prime the grease gun 10. The membrane disk 50 retains grease in the pump housing 18 while allowing the air to escape. It will be appreciated that the clean-priming operation is performed using substantially similar user behavior (e.g., opening a valve 62) as conventional priming operations, while improving the priming operation by inhibiting the accumulation of grease on the outside of the grease gun 10.

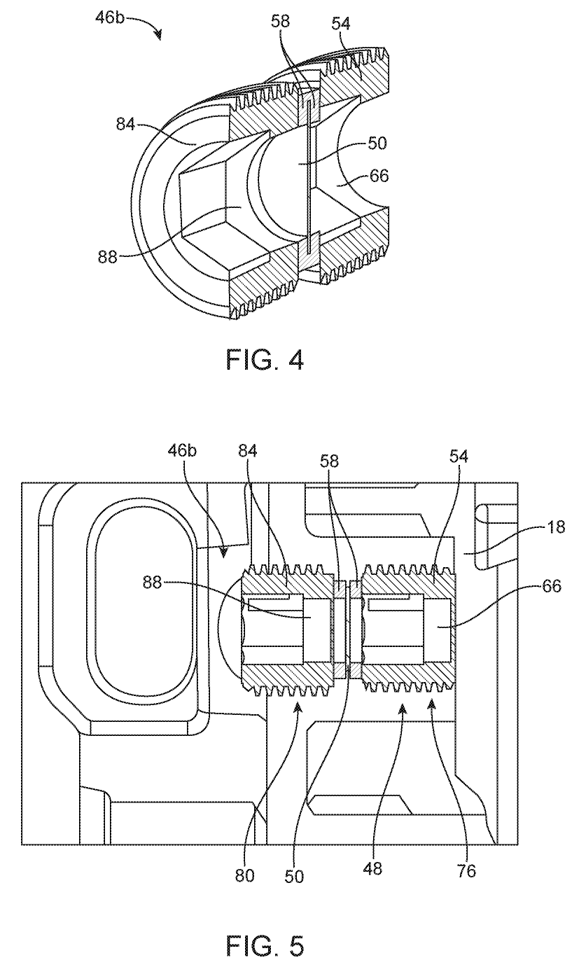

With reference to FIGS. 4 and 5, a second embodiment of an air vent 46b includes a membrane disk 50 supported by a first plug 54, seals 58 and a second plug 84. Each of the first and second plugs 54, 84 have a bore 66, 88 through the center. The first plug 54 is positioned in the vent bore 48 on an interior side 76 of the membrane disk 50, and the second plug 84 is positioned in the vent bore 48 on the exterior side 80 of the membrane disk 50. In the illustrated embodiment, the first plug 54 and the second plug 84 are threadably coupled to the grease gun within the vent bore 48. In other embodiments, the first plug 54 and the second plug 84 may be coupled to the grease gun in other manners. The seals 58 sandwich the membrane disk 50 between the first plug 54 and the second plug 84. In the illustrated embodiment, the seals 58 are O-rings. In other embodiments, the seals 58 may be other suitable seals. In the second embodiment, the grease gun 10 is configured in an auto-priming configuration, in which the air vent 46b is continuously open (via the bores 66, 88 in the first and second plugs 54, 84), allowing air to vent continuously through the membrane disk 50 to the exterior of the grease gun 10 while the membrane disk 50 retains the grease in the pump housing 18. It will be appreciated that auto-priming configuration does not require intervention by the user to open a valve nor does it require a button or other structure to open a valve and therefore reduces the size of the grease gun.

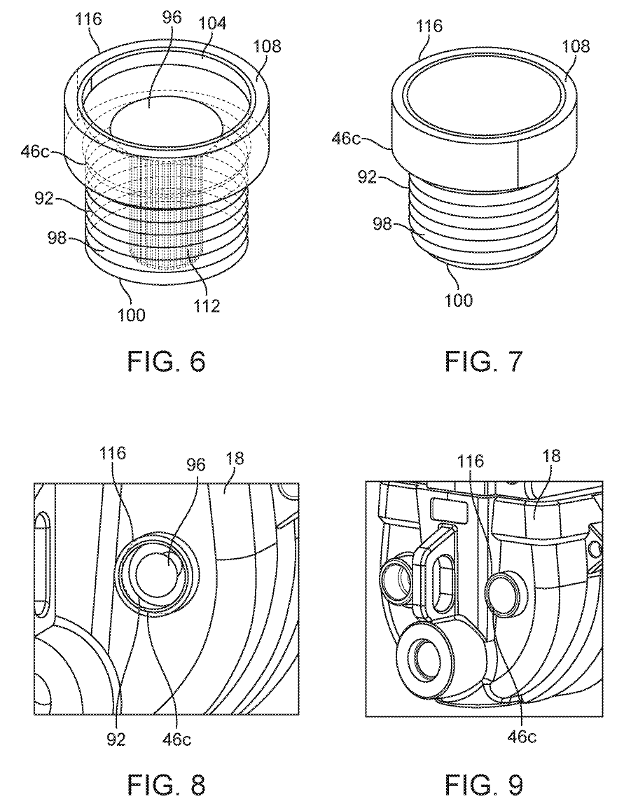

FIGS. 6-9 illustrate another embodiment of an air vent 46c. The air vent 46c includes a plug 92 to which a membrane disk 96 is coupled. In the present embodiment, the membrane disk 96 is molded onto the plug 92. In other embodiments, the membrane disk 96 may be coupled to the plug 92 in another manner. Like the membrane disk 50 above, the membrane disk 96 includes membrane materials that are oleophobic and hydrophobic, which allow air to pass through the membrane disk 96, but do not allow water, grease, or oil to pass through. In some embodiments, the membrane disk 96 may be oleophobic. In other embodiments, the membrane disk 96 may be hydrophobic. In still other embodiments, such as the illustrated embodiments, the membrane disk 96 may be both oleophobic and hydrophobic. The membrane disk 96 may be comprised of one material that is both oleophobic and hydrophobic, or may instead comprise more than one material, with one material being oleophobic and another material being hydrophobic. In some embodiments, the membrane disk 50 may be coated with an oleophobic coating and/or a hydrophobic coating, making the membrane disk oleophobic and/or hydrophobic. The membrane disk 96 therefore allows air to pass through the air vent 46c to be expelled to the exterior of the grease gun 10, while retaining the grease in the flow path 26, eliminating grease accumulation on the housing 42 of the grease gun 10 occurring during a priming operation.

The plug 92 is coupled to the pump housing 18 by threading 98 extending from a first end 100 of the plug 92. When coupled to the pump housing 18, the threading 98 extends at least partially into the vent bore 48. The plug 92 has a recess 104 extending into the plug 92 from the second end 108 and a vent bore 112 extending through the plug 92. The membrane disk 96 is positioned in the recess 104, covering the vent bore 112. A cap 116 is coupled to the second end 108 of the air vent 46c to cover the recess 104. In one embodiment, the cap 116 may be coupled to the plug 92 and may be slidable relative to the plug 92 while being retained on the second end 108 of the plug 92. In that embodiment, the air vent 46c is configured to operate in an auto-priming configuration in which air is allowed to pass through the vent bore 112 and membrane disk 96, and past the cap 116, without intervention by a user to allow air to pass through the air vent 46c. In another embodiment, the cap 116 may be coupled to the plug 92 in a manner (e.g., a threaded connection) that requires user intervention to remove the cap 116 from the plug 92 in order to allow air in the pump assembly 14 and/or flow path 26 to pass through the membrane disk 96 to the exterior of the grease gun 10. In such embodiments, the cap 116 may also be considered a valve. In that embodiment, the grease gun 10 is operable in a clean-priming configuration.

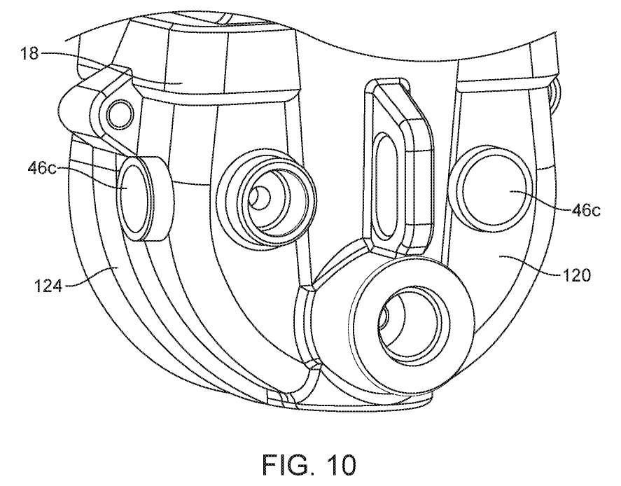

With reference to FIG. 10, the grease gun may include more than one air vent coupled to the pump housing 18 or to any other component of the grease gun that is in fluid communication with the flow path 26. For example, the grease gun may include two or more air vents. In the embodiment in FIG. 10, a first air vent 46c is coupled to an end 120 of the pump housing 18 and a second air vent 46c is coupled to a side 124 of the pump housing 18. In other embodiments, each air vent 46c may be located elsewhere on the pump housing 18. The air vents shown in FIG. 10 may be any of the air vents 46a, 46b, 46c described above. For example, one of the air vents may be the air vent 46a and another of the air vents may be the air vent 46c.

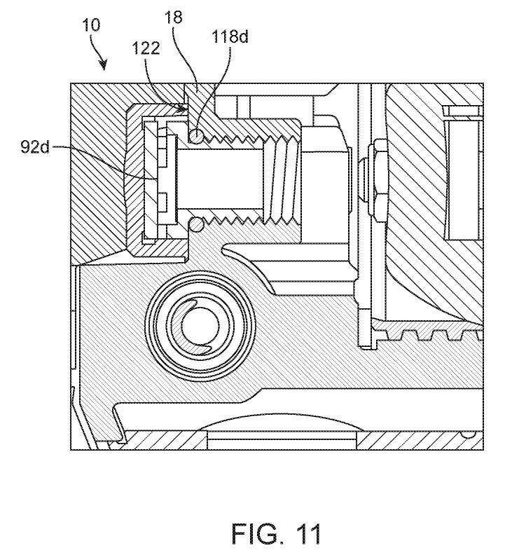

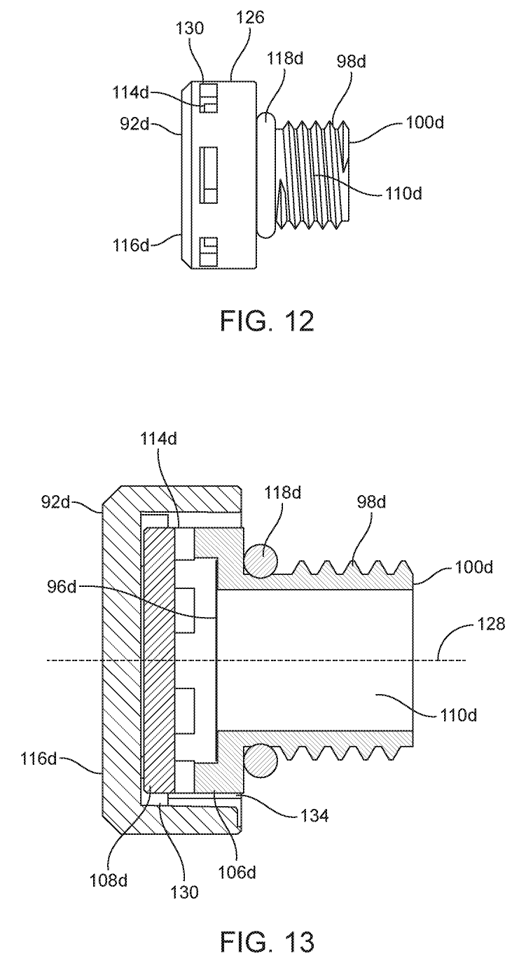

FIGS. 11-13 illustrate another embodiment of an air vent 46d that can be coupled to the pump housing 18 of a grease gun 10. The air vent 46d includes a plug 92d that defines a vent bore 112d extending from a first end 100d of the plug 92d. A head portion 106d is positioned at the second end 108d of the plug 92d. Threading 98d extends along the exterior of the stem portion 110d of the plug 92d from the first end 100d to the head portion 106d. The head portion 106d has a substantially cylindrical shape. A plurality of openings 114d (e.g., rectangular openings) are radially equally spaced about the head portion 106d. A membrane disk 96d is positioned within the head portion 106d covering the vent bore 112d. The membrane disk 96d should be understood to be a membrane disk similar to the previously described embodiments (e.g., as a disk having one or both of oleophobic or hydrophobic properties or a composite of two disks, each having one of a hydrophobic or oleophobic properties). The membrane disk 96d may be coupled to the plug 92d in any appropriate manner (e.g., adhesive). A sealing member 118d (e.g., an elastomeric O-ring) is positioned on the stem portion 110d at the juncture between the stem portion 110d and the head portion 106d. When the air vent 46d is coupled to the pump housing 18, the sealing member 118d forms a sealed interface 122 between the pump housing 18 and the plug 92d.

The air vent 46d also includes a cap 116d that covers the second end 108d of the plug 92d and at least partially circumferentially surrounds the cylindrical side 126 of the head portion 106d. The cap 116d includes a plurality of openings 130 radially spaced about the cylindrical side 126 of the cap 116d. In the illustrated embodiment, the plurality of openings 130 of the cap 116d are radially aligned about the plug axis 128 with the plurality of openings 114d of the plug 92d. In other embodiments, the plurality of openings 114d of the plug 92d are in fluid communication with the plurality of openings 130. Ridges 134 in the interior of the cap 116d may engage the head portion 106d to space the side 126 of the cap 116d from the head portion 106d. Air can flow through the openings 114d of the plug 92d and the openings 130 of the cap 116d to vent from the grease gun 10.

While the embodiments disclosed above relate to a grease gun, the subject matter could be used in another assembly that includes a pump assembly configured to pump another viscous fluid while permitting air to exit the flow path.

It should be understood that features of any of the embodiments described above may be incorporated with any of the other embodiment.

Although the subject matter has been described in detail with reference to certain preferred embodiments, variations and modifications exist within the scope and spirit of one or more independent aspects of the subject matter as described.

1. A grease gun comprising:
a housing;
a motor supported in the housing;
a pump assembly coupled to and driven by the motor;
a pump housing supported in the housing and at least partially supporting the pump assembly, the pump housing at least partially defining a flow path; and
an air vent supported in the pump housing in fluid communication with the pump assembly and the flow path, the air vent configured to allow air to pass through the air vent to an exterior of the pump housing while retaining other fluids within the pump housing.

2. The grease gun of claim 1, wherein the air vent contains a membrane that permits air to pass to the exterior of the pump housing.

3. The grease gun of claim 2, wherein the membrane is hydrophobic.

4. The grease gun of claim 2, wherein the membrane is oleophobic.

5. The grease gun of claim 2, wherein the membrane is hydrophobic and oleophobic.

6. The grease gun of claim 2, wherein the air vent includes a plug supporting the membrane.

7. The grease gun of claim 5, wherein the membrane is molded onto the plug.

8. The grease gun of claim 1, wherein the air vent is a first air vent, the grease gun further comprising a second air vent coupled to the pump housing.

9. The grease gun of claim 1, wherein the air vent includes a valve that is selectively opened by a user.

10. The grease gun of claim 1, wherein the air vent is continuously open.

11. An air vent for use with a grease gun having a pump housing at least partially defining a flow path, the air vent comprising:
a plug configured to be coupled to the grease gun in communication with the flow path; and
a membrane coupled to the plug, the membrane configured to allow air to pass through the plug to an exterior of the grease gun while retaining other fluids within the grease gun.

12. The grease gun of claim 11, wherein the membrane is hydrophobic.

13. The grease gun of claim 11, wherein the membrane is oleophobic.

14. The grease gun of claim 11, wherein the membrane is hydrophobic and oleophobic.

15. The grease gun of claim 11, wherein the membrane is molded onto the plug.

16. A grease gun comprising:
a housing;
a motor supported in the housing;
a pump assembly coupled to and driven by the motor;
a pump housing supported in the housing and at least partially supporting the pump assembly, the pump housing at least partially defining a flow path;
an air vent supported in the pump housing in fluid communication with the pump assembly and the flow path, the air vent configured to allow air to pass through the air vent to an exterior of the pump housing while retaining other fluids within the pump housing; and
a membrane at least partially supported in the air vent that permits air to pass to the exterior of the pump housing.

17. The grease gun of claim 16, further comprising a plug coupled to the air vent.

18. The grease gun of claim 2, wherein the membrane is hydrophobic.

19. The grease gun of claim 2, wherein the membrane is oleophobic.

20. The grease gun of claim 2, wherein the membrane is hydrophobic and oleophobic.
